(19) United States
(12) Patent Application Publication
(10) Pub. No.: US 2026/0332384 A1
(43) Pub. Date: Oct. 22, 2026

(54) SYSTEMS AND METHODS FOR PROVIDING SECURE THIRD-PARTY FUNCTION EXECUTION AND SECURE MULTI-PARTY ANALYTICS CALCULATION

(71) Applicant: Verizon Patent and Licensing Inc., Basking Ridge, NJ (US)

(72) Inventors: Raghuram PARVATANENI, Frisco, TX (US); Matthew WINDT, New York, NY (US)

(73) Assignee: Verizon Patent and Licensing Inc., Basking Ridge, NJ (US)

(21) Appl. No.: 19/185,787

(22) Filed: Apr. 22, 2025

(51) Int. Cl. H04L 9/00; H04L 9/08

(52) U.S. Cl. CPC H04L 9/008; H04L 9/0825

(57) ABSTRACT

A device may receive, from a third party, a request to execute a function associated with encrypted customer data, and may determine whether the request is valid based on one or more security policies. The device may provide the function in a secure platform based on determining that the request is valid, and may decrypt, within the secure platform, a portion of the encrypted customer data needed for execution of the function to generate a portion of the customer data. The device may execute, within the secure platform, the function with the portion of the customer data to generate a minimal result, and may encrypt the minimal result to generate an encrypted minimal result. The device may provide the encrypted minimal result to the third party.

### BACKGROUND

Enterprises and telecommunications providers are increasingly faced with the challenge of securely sharing sensitive customer data with external partners (e.g., financial institutions and government agencies) for purposes such as fraud management, credit scoring, and insurance underwriting. However, privacy concerns and stringent regulatory requirements necessitate a delicate balance between granting necessary data access for third-party functions and safeguarding the confidentiality of customer data.

### BRIEF DESCRIPTION OF THE DRAWINGS

FIGS. 1A-1H are diagrams of an example associated with providing secure third-party function execution and secure multi-party analytics calculation.

FIG. 2 is a diagram of an example environment in which systems and/or methods described herein may be implemented.

FIG. 3 is a diagram of example components of one or more devices of FIG. 2.

FIG. 4 is a flowchart of an example process for providing secure third-party function execution and secure multi-party analytics calculation.

### DETAILED DESCRIPTION OF EXAMPLE EMBODIMENTS

The following detailed description of example implementations refers to the accompanying drawings. The same reference numbers in different drawings may identify the same or similar elements.

In a telecommunications environment, providers possess valuable customer data, including customer identity data, device status, and usage patterns, which are crucial for preventing fraud, verifying user identities, and detecting account takeovers. However, sharing raw customer data or using aggregator-based solutions introduces risks of data privacy breaches and misuse. Consequently, there is a compelling need for a secure platform that allows multiple agencies to submit queries or algorithms for fraud detection without compromising the privacy of the customer data or the confidentiality among participating entities. Similarly, enterprises need to allow third-party services to perform functions like location validation or credit risk scoring while ensuring minimal data exposure and maintaining auditable access with comprehensive logging. Enterprises must also ensure that only policy-driven, pre-approved logic is executed on sensitive customer data and tailored to specific use cases.

Thus, current techniques for handling sensitive customer data consume computing resources (e.g., processing resources, memory resources, communication resources, and/or the like), networking resources, and/or other resources associated with handling privacy breaches of sensitive customer data, handling misuse of sensitive customer data, failing to establish a secure computation environment where third-party logic may be executed without exposing raw customer data, failing to control and limit access to customer data according to predefined rules, failing to provide an auditable system that can log every action taken on the customer data, while preserving the privacy and confidentiality requirements of customer data, and/or the like.

Some implementations described herein provide a security system that provides secure third-party function execution and secure multi-party analytics calculation. For example, the security system may receive, from a third party, a request to execute a function associated with encrypted customer data, and may determine whether the request is valid based on one or more security policies. The security system may provide the function in a secure platform based on determining that the request is valid, and may decrypt, within the secure platform, a portion of the encrypted customer data needed for execution of the function to generate a portion of the customer data. The security system may execute, within the secure platform, the function with the portion of the customer data to generate a minimal result, and may encrypt the minimal result to generate an encrypted minimal result. The security system may provide the encrypted minimal result to the third party, and may log details associated with execution of the function.

In this way, the security system provides secure third-party function execution and secure multi-party analytics calculation. For example, the security system may enable secure execution of third-party functions while maintaining the confidentiality of sensitive customer data. The security system may utilize a secure platform that ensures that sensitive information is processed in a protected environment that is inaccessible to unauthorized parties. The security system also includes policy enforcement mechanisms that provide granular control over data access. The security system may provide auditable logs that efficiently track and record only essential information related to data access and function execution. By providing robust security measures, the security system adheres to stringent data protection regulations and minimizes the risk of unauthorized data access or breaches. Thus, the security system may conserve computing resources, networking resources, and/or other resources that would have otherwise been consumed by handling privacy breaches of sensitive customer data, handling misuse of sensitive customer data, failing to establish a secure computation environment where third-party logic may be executed without exposing raw customer data, failing to control and limit access to customer data according to predefined rules, failing to provide an auditable system that can log every action taken on the customer data, while preserving the privacy and confidentiality requirements of customer data, and/or the like.

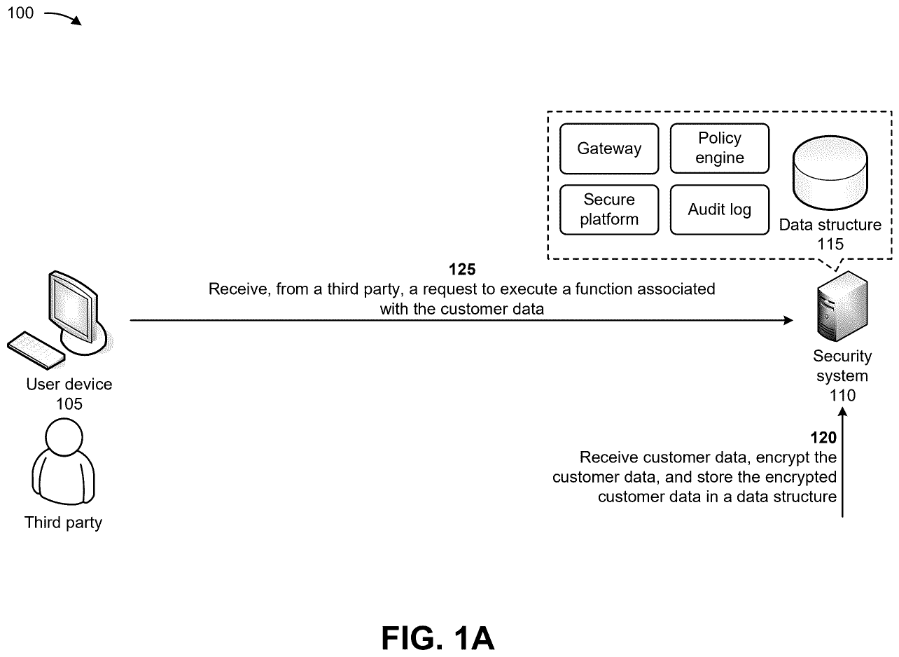

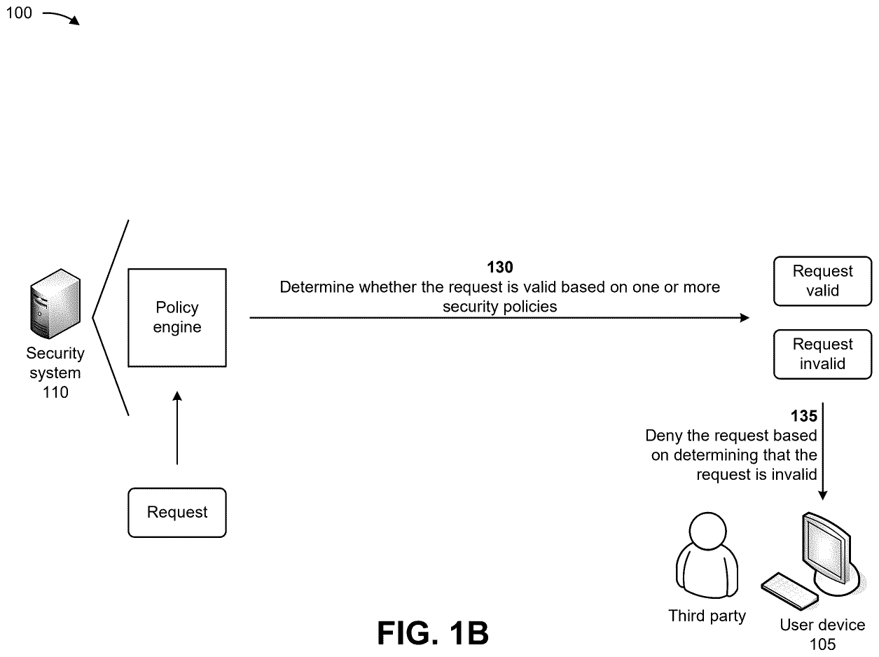

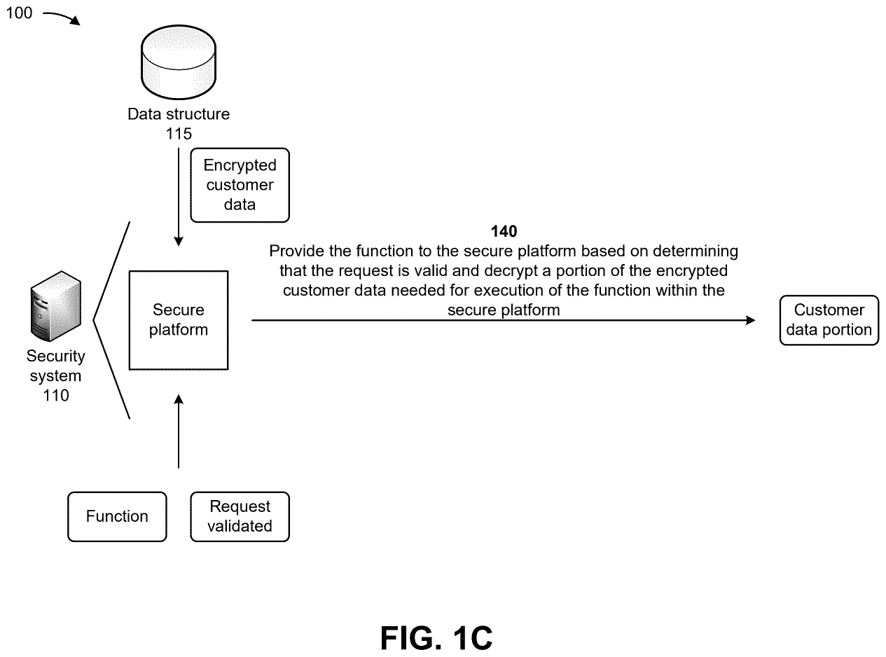

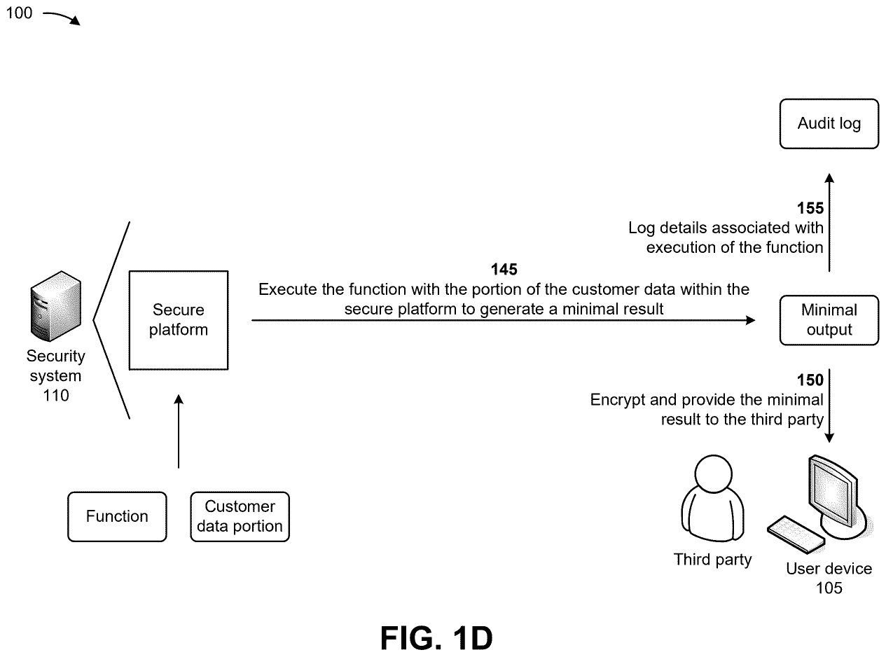

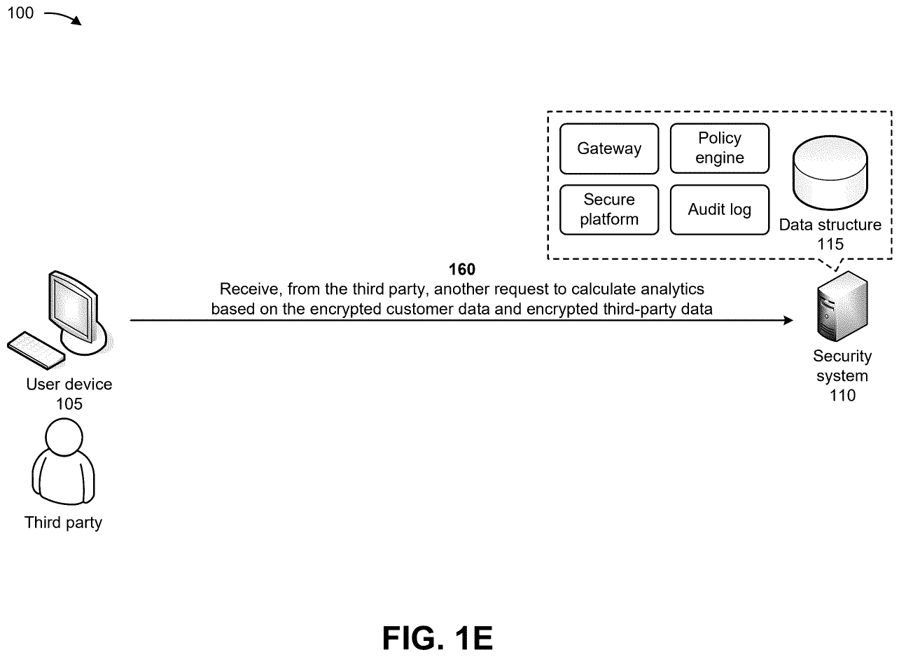

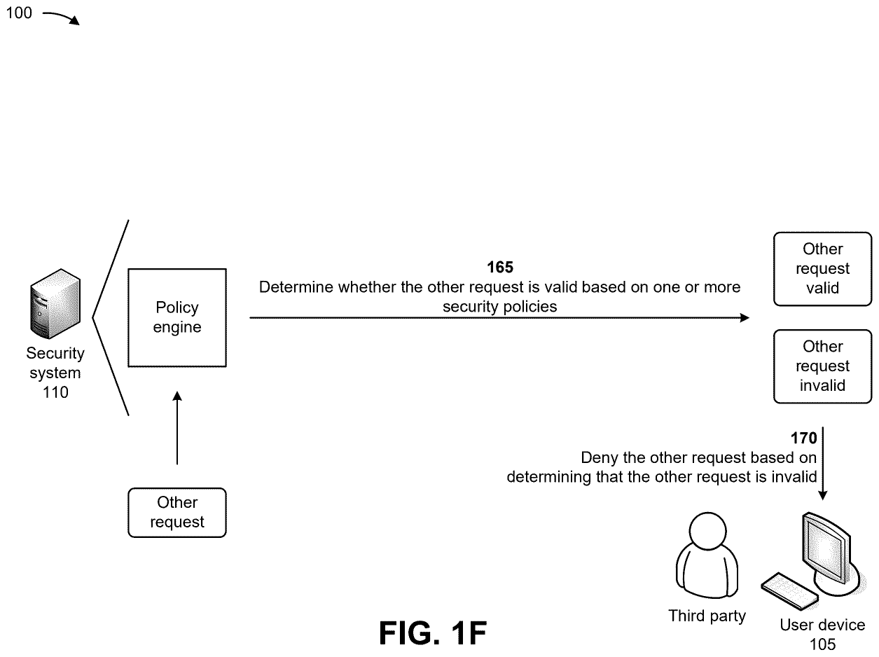

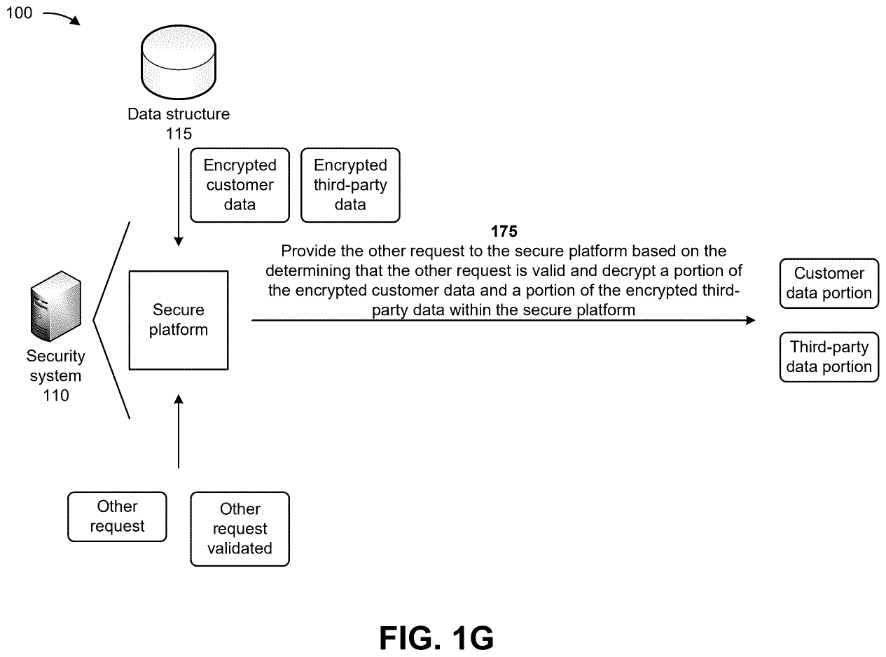

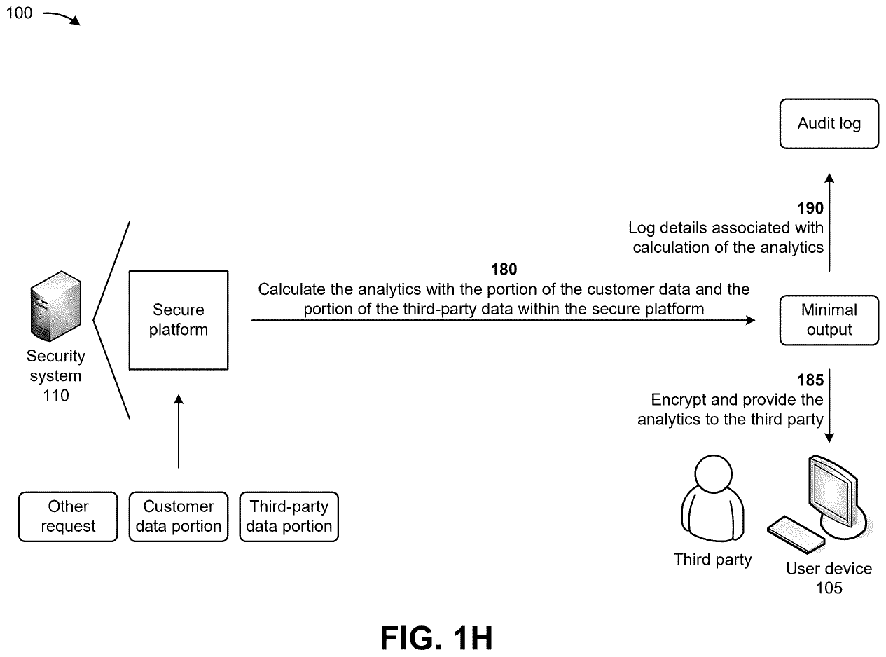

FIGS. 1A-1H are diagrams of an example 100 associated with providing secure third-party function execution and secure multi-party analytics calculation. As shown in FIGS. 1A-1H, the example 100 includes a user device 105 associated with a third party, a security system 110, and a data structure 115. The third party may utilize the user device 105 to interact with the security system 110 and/or the data structure 115. The security system 110 may include a system that provides secure third-party function execution and secure multi-party analytics calculation. The data structure 115 may include a database, a table, a list, and/or the like that stores information. Further details of the user device 105, the security system 110, and the data structure 115 are provided elsewhere herein. Although implementations described herein depict a single user device 105 and a single data structure 115, in some implementations, the security system 110 may be associated with multiple user devices 105 and/or multiple data structures 115.

As shown in FIG. 1A, the security system 110 may include a gateway, a policy engine, a secure platform, an audit log, and the data structure 115. The gateway may include a network device (e.g., a router, a gateway, a switch, a firewall, a hub, a bridge, a reverse proxy, a server (e.g., a proxy server, a cloud server, or a data center server), a load balancer, and/or a similar device. The gateway may receive function requests from third parties and may check with the policy engine to determine whether the function requests and/or data usage are permitted. In some implementations, the gateway may receive analytics requests or queries (e.g., via an application programming interface (API)) from third parties and may check with the policy engine to determine whether the analytics requests or queries and/or data usage are permitted.

The policy engine may determine whether the function requests, the analytics requests, and/or data usage are permitted. Policy engine may provide fine-grained access control to the security system 110, and may be implemented via tools, such as open policy agent (OPA), Rego policy language, or custom attribute-based access control (ABAC) frameworks. The policy engine may enable a policy administrator to define data usage policies in a central policy service (e.g., a fraud detection function can only use location data, and only for real-time checks). The policies may define who can utilize the security system 110, what functions can be processed by the security system 110, when the functions can be executed, purpose requirements of the functions, and audit log requirements. The policy engine may check a function request against data usage policies. If all conditions match (e.g., the function is allowed to access this data attribute, or the request is within allowed time frames), the secure platform may be granted ephemeral access to the relevant data for executing the function. The policy engine may utilize a specialized policy language (e.g., Rego for OPA) or a role-based/attribute-based approach that includes context (e.g., purpose of use, data fields required, and/or the like). The security system 110 may include several policy enforcement points (PEPs), such as at the gateway, at the policy engine, at data service layers, and at the entry to the secure platform.

In some implementations, the policy engine may provide policy enforcement that ensures that each third party (e.g., each agency) can only query or execute analytics relevant to anti-fraud use cases. The policy engine may manage complex multi-party relationships (e.g., different risk tiers, know your customer (KYC) levels, regulatory constraints, and/or the like). The policy engine may validate which third parties can execute which queries and may orchestrate data flow in the security system 110.

The secure platform may provide a secure and trusted execution environment (TEE), such as, for example, Intel software guard extensions (SGX), AMD secure encrypted visualization (SEV), and Amazon web services (AWS) Nitro enclave environments. The secure platform may provide isolated, hardware-level secure regions in which code and data remain protected—even from a host operating system. Third parties may deploy their functions and analytics requests inside the secure platform, and the secure platform may only produce encrypted results or minimal outputs. In some implementations, the secure platform may provide a privacy-preserving framework, such as an Oasis Labs framework, a conclave (R3) framework, or a confidential consortium framework. When a third party (or external system) invokes a function, the security system 110 may load the authorized function binary into the secure platform where data may be decrypted in-memory only. The secure platform may verify the function's signature to ensure that the function has not been tampered with. The function may be securely executed within the secure platform, and the secure platform may generate results (e.g., a risk score, a yes/no decision, aggregated data, and/or the like). The secure platform may return a minimal necessary output to the third party (and optionally to an enterprise). In some implementations, the secure platform may securely calculate joint analytics (e.g., risk scores, fraud alerts, and/or the like) based on combining partial data from multiple agencies. The secure platform may enable each entity (e.g., a telecommunications provider, a bank, an agency, and/or the like) to only see final aggregated results, not raw data from the other entities. In one example, the secure platform may receive partial data from a telecommunications provider's customer database and from each agency's private databases, and may calculate an aggregated risk score within the secure platform and without revealing underlying personally identifiable information (PII). In some implementations, the secure platform may include a TEE or a multi-party-computation (MPC)-based environment that merges partial data from the telecommunications provider's customer database and from each agency's private databases for real-time or batch computations. The MPC-based environment may include a cryptographic protocol that allows multiple parties to jointly compute a function over their inputs while keeping those inputs private. In some implementations, the secure platform may provide a hybrid processing model, such as a TEE cluster for high-performance, real-time fraud detection and an MPC environment for highly sensitive operations requiring multi-party consensus. The secure platform may provide for dynamic routing between the TEE and the MPC environment based on data sensitivity and performance requirements. In one example, the secure platform may perform multi-level fraud detection that includes a first level (e.g., a pattern-based detection using cached rules), a second level (e.g., a machine learning model based anomaly detection in the TEE), a third level (e.g., a multi-party consensus through MPC), and a fourth level (e.g., a graph-based relationship analysis).

The audit log may include data generated during execution of a function or during calculation of analytics. The data may include an identity of who or what generated a request for the function or the analytics, a timestamp of the request, input parameters provided in the request, a function identifier, an analytics identifier, policy references, data usage, or a result or type of output produced. The audit log may be stored in a secure audit system (e.g., immutably on a distributed ledger, or via a secure logging service). The audit log may capture function or analytics inputs (e.g., metadata) and outputs (e.g., metadata, not raw data). A security information and event management (SIEM) system or a blockchain-based ledger may be utilized to ensure that the audit log is tamperproof. In some implementations, the audit log may include a log for every query execution, to ensure compliance and accountability.

The data structure 115 may store customer data from a telecommunications provider, private data from agencies (e.g., third parties), and/or the like. The data structure 115 may store data in an encrypted format, such as a homomorphic encryption (HE) format (e.g., a form of encryption that allows computations to be carried out on ciphertext, generating an encrypted result that, when decrypted, matches the result of operations performed on the plaintext and enables secure data processing without exposing the underlying data), a functional encryption format (e.g., a cryptographic approach that allows decrypting only specific “functions” of the data rather than full plain text), and/or the like. In some implementations, the data structure 115 may receive sensitive customer data from the telecommunications provider and private data from third parties. The data structure 115 may encrypt the data with a key management service. All keys may remain under enterprise control, and third parties never handle keys that can directly decrypt the data. The data structure 115 may anonymize or tokenize sensitive fields of the stored data before providing the stored data to the secure platform. This may mitigate security risks in case of accidental leakage of data outside the secure platform. In some implementations, the data structure 115 may utilize zero knowledge proofs (ZKPs) for certain scenarios to verify statements about data without revealing the data). For example, a third party may prove that a user is located in a certain region without revealing the user's exact location. For analytics use cases (e.g., aggregated queries), the data structure 115 may apply differential privacy noise so that results do not reveal details of individuals in the dataset. The data structure 115 may provide, to the secure platform, only the encrypted data necessary for execution of a function or calculation of analytics.

In some implementations, the data structure 115 may provide advanced data management. For example, the data structure 115 may provide a Redis cache for sub-millisecond fraud pattern matching, a time series database for pattern analysis and anomaly detection, a graph database for relationship analysis and fraud ring detection, and a key-value store for rapid customer profile lookup. Alternatively, or additionally, the data structure 115 may provide a smart caching strategy. For example, the data structure may provide a hot cache (e.g., a last twenty-four hours of fraud patterns), a warm cache (e.g., thirty days of customer behavior profiles), and a cold storage (e.g., historical data for training and analysis).

As shown in FIG. 1A, and by reference number 120, the security system 110 may receive customer data, may encrypt the customer data, and may store the encrypted customer data in the data structure 115. For example, the security system 110 may receive customer data from a telecommunications provider or another entity that manages sensitive data. In some implementations, the security system 110 may continuously receive the customer data from the telecommunications provider or other entity, may periodically receive the customer data from the telecommunications provider or other entity, may receive the customer data from the telecommunications provider or other entity based on requesting the customer data, and/or the like. The customer data may include data identifying identities of customers (e.g., PII), statuses of subscriber identity module (SIM) cards of customers, usage patterns of customers, historical locations of customers, and/or the like.

The security system 110 may encrypt the customer data using a key management service to generate encrypted customer data. In some implementations, the security system 110 may encrypt the customer data in a homomorphic encryption format, a functional encryption format, and/or another secure format. The security system 110 may anonymize or tokenize sensitive fields of the customer data before the customer data is provided to the secure platform. For example, the security system 110 may anonymize location data or tokenize PII to mitigate security risks. The security system 110 may apply data anonymization techniques that remove or obfuscate identifiable information from the customer data to protect customer privacy. In some implementations, the security system 110 may encrypt the customer data using a public key infrastructure (PKI). The PKI may ensure secure and authenticated encryption and decryption processes. Additionally, or alternatively, the security system 110 may encrypt the customer data using symmetric key cryptography. Symmetric key cryptography involves using the same key for both encryption and decryption processes. In some implementations, the security system 110 may store the encrypted customer data in the data structure 115.

As further shown in FIG. 1A, and by reference number 125, the security system 110 may receive, from a third party, a request to execute a function associated with the customer data. For example, a third party (e.g., a financial institution, a government agency, and/or the like) may utilize the user device 105 to interact with the security system 110. The third party may cause the user device 105 to generate the request to execute the function with the customer data. The user device 105 may provide the request to execute the function associated with the customer data to the security system 110, and the security system 110 may receive the request. In some implementations, the gateway of the security system 110 may receive the request from the user device 105 via an API, a direct input, and/or the like. The request may include details about the function to be executed, such as a function identifier, input parameters, and/or a purpose of the function (e.g., fraud detection, credit scoring, and/or the like). In some implementations, the request may be encrypted by the user device 105 prior to being provided to the security system 110.

In some implementations, the request may include a request to perform a specific analysis on the customer data, such as a trend analysis, segmentation, predictive analytics, and/or the like. Additionally, or alternatively, the request may include a request to execute a machine learning model on the customer data. The machine learning model may include a classification model, a regression model, a neural network, and/or the like that derives insights from the customer data. Additionally, or alternatively, the request may include a request to aggregate and analyze the customer data for compliance reporting. Compliance reporting may involve generating reports that adhere to regulatory requirements and standards for data usage and security.

As shown in FIG. 1B, and by reference number 130, the security system 110 may determine whether the request is valid based on one or more security policies. For example, the security system 110 may utilize the policy engine to analyze the request for execution of the function. The policy engine may apply predefined rules and criteria to assess the validity of the request, and may ensure that the requested function adheres to established data usage policies. The security policies may define specific conditions, such as the type of customer data fields that can be accessed, a purpose of the function, a time frame within which the function can be executed, and/or the like. The security policies may include data access control policies (e.g., only authorized third parties can access specific types of customer data based on roles and credentials); data usage policies (e.g., the customer data can only be used for predefined and approved purposes, specific data fields can only be accessed for certain types of analyses or functions, and usage of data must comply with regulatory requirements and privacy laws); and/or multi-party data sharing policies (e.g., data sharing between multiple parties must be governed by strict confidentiality agreements, only aggregated results or minimal necessary outputs can be shared between parties to prevent exposure of raw data, and multi-party computations must ensure that no single party can access the complete dataset).

The policy engine may verify whether the request for execution of the function satisfies all required security policies before providing the request to the secure platform. In some implementations, the security system 110 may determine that the request is invalid based on determining that the request for execution of the function fails to satisfy one or more of the security policies. Alternatively, the security system 110 may determine that the request is valid based on determining that the request for execution of the function satisfies all of the security policies.

As further shown in FIG. 1B, and by reference number 135, the security system 110 may deny the request based on determining that the request is invalid. For example, if the policy engine of the security system 110 determines that the request fails to satisfy one or more of the security policies, the security system 110 may reject the request and may prevent the function from being executed. The security system 110 may communicate the denial of the request to the third party via the user device 105, and may provide an explanation for the denial of the request based on specific security policy violations. This may ensure that unauthorized or non-compliant requests are not processed, thereby maintaining the integrity and confidentiality of the customer data within the security system 110. The third party may utilize the explanation for the denial of the request to modify the request and to cause the user device 105 to provide a modified request for execution of the function to the security system 110. Furthermore, if the policy engine of the security system 110 determines that the request fails to satisfy one or more of the security policies, the security system 110 may prevent the request from being provided to the secure platform.

As shown in FIG. 1C, and by reference number 140, the security system 110 may provide the function to the secure platform based on determining that the request is valid and may decrypt a portion of the encrypted customer data needed for execution of the function within the secure platform. For example, if the policy engine of the security system 110 determines that the request satisfies the security policies, the security system 110 may provide the request for execution of the function to the secure platform of the security system 110. In some implementations, the secure platform may include a trusted execution environment that ensures the integrity and confidentiality of the customer data during execution of the function. In some implementations, the security system 110 may analyze the function and may determine the portion of the encrypted customer data needed for execution of the function within the secure platform based on analyzing the function. For example, the security system 110 may analyze the function in order to understand what specific data fields or data elements are necessary for execution of the function. This may include examining the function's logic, input parameters, and the type of operation it is intended to perform (e.g., fraud detection, credit scoring, and/or the like). Based on the function analysis, the security system 110 may map the required data fields from the encrypted customer data. The mapping may identify the portion of the customer data that is necessary for execution of the function.

Once the portion of the encrypted customer data (e.g., the required data fields) is identified, the secure platform of the security system 110 may decrypt only the portion of the encrypted customer data to generate a portion of the customer data. This selective decryption may ensure that only the minimal necessary customer data is exposed within the secure platform, maintaining the confidentiality and integrity of the remaining customer data. For example, the security system 110 may provide the portion of the encrypted customer data to the secure platform, and may authorize the secure platform to decrypt the portion of the encrypted customer data. In some implementations, the secure platform may utilize decryption techniques such as homomorphic decryption, functional decryption, and/or other cryptographic methods to securely manage the decryption of the encrypted customer data. For example, the secure platform may decrypt the portion of the encrypted customer data in-memory only and may prevent exposure of raw data to unauthorized entities.

As shown in FIG. 1D, and by reference number 145, the security system 110 may execute the function with the portion of the customer data within the secure platform to generate a minimal result. For example, the secure platform of the security system 110 may execute the function using the decrypted portion of the customer data to generate the minimal result. The secure platform may ensure that the function is executed in a protected environment where sensitive customer data is processed securely. The minimal result may include information derived from the portion of the customer data that is necessary for the third party's request, such as a risk score, a yes/no decision, aggregated data, and/or the like.

In some implementations, executing the function with the portion of the customer data to generate the minimal result may include additional processing steps, such as data validation or integrity checks, before generating the minimal result. For example, the security system 110 may validate the integrity of the decrypted portion of the customer data to ensure that the data has not been tampered with. Additionally, or alternatively, the security system 110 may format the minimal result according to the third party's requirements before encrypting the minimal request. For example, the minimal result may be formatted to match a data structure expected by a system (e.g., an enterprise system) associated with the third party.

As further shown in FIG. 1D, and by reference number 150, the security system 110 may encrypt the minimal result and may provide the encrypted minimal result to the third party. For example, after generating the minimal result, the security system 110 may encrypt the minimal result using a secure encryption format (e.g., a homomorphic encryption format, a functional encryption format, a public key infrastructure format, or a symmetric key cryptography format) to ensure its confidentiality. The security system 110 may provide the encrypted minimal result to the third party via the user device 105. The encryption may ensure that the minimal result remains protected during transmission to the user device 105 and can only be decrypted by authorized entities. In some implementations, the security system 110 may utilize different encryption algorithms based on the sensitivity of the minimal result. For example, highly sensitive results may be encrypted using stronger algorithms like the AES-256 cryptographic algorithm, while less sensitive results may use the AES-128 cryptographic algorithm. Additionally, or alternatively, the security system 110 may provide the minimal result to multiple third parties if requested and authorized. For example, the security system 110 may provide the encrypted minimal result to multiple authorized third parties who have a legitimate need for the information. Additionally, or alternatively, the security system 110 may implement a secure transmission protocol, such as the transport layer security (TLS) protocol, to further ensure the confidentiality of the encrypted minimal result during transit. For example, the security system 110 may utilize the TLS protocol to create a secure channel for transmitting the encrypted minimal result to user device 105.

As further shown in FIG. 1D, and by reference number 155, the security system 110 may log details associated with execution of the function. For example, the security system 110 may generate an audit log that captures key information related to the function execution. This may include details such as the identity of the requester (e.g., the third party), timestamps of the request and function execution, input parameters used, a function identifier, references to applicable security policies, a type of minimal result produced, and/or the like. The audit log may be stored in a secure audit system to ensure its integrity and accessibility for compliance and accountability purposes. In some implementations, the audit log may include additional details such as the duration of the function execution and resource utilization metrics. For example, the audit log may capture how long the function took to execute and the computational resources consumed when executing the function. Additionally, or alternatively, the security system 110 may implement anomaly detection mechanisms to identify and respond to unusual patterns stored in the audit log. For example, the security system 110 may flag and investigate function executions that deviate from normal patterns, indicating potential security threats. Additionally, or alternatively, the security system 110 may integrate the audit log with external compliance and monitoring systems to provide real-time alerts and notifications based on logged details. For example, the audit log may be linked to a compliance monitoring system that sends alerts if certain conditions occur, such as unauthorized access attempts.

As shown in FIG. 1E, and by reference number 160, the security system 110 may receive, from the third party, another request to calculate analytics based on the encrypted customer data and encrypted third-party data. For example, a third party (e.g., a financial institution, a government agency, and/or the like) may utilize the user device 105 to interact with the security system 110. The third party may cause the user device 105 to generate the request to calculate analytics based on the encrypted customer data and encrypted third-party data. The user device 105 may provide the request to calculate analytics to the security system 110, and the security system 110 may receive the request. In some implementations, the gateway of the security system 110 may receive the request from the user device 105 via an API, a direct input, and/or the like. The request may include details about the analytics to be calculated, such as an analytics identifier, input parameters, and/or a purpose of the analytics (e.g., fraud detection, credit scoring, and/or the like). In some implementations, the request may be encrypted by the user device 105 prior to being provided to the security system 110.

The encrypted third-party data may include data provided by an external entity (such as a financial institution, government agency, or another organization) that has been encrypted to ensure its confidentiality and security. For example, the encrypted third-party data may include financial transactions data (e.g., encrypted records of transactions, encrypted credit card numbers, encrypted bank account information, and/or the like); healthcare data (e.g., encrypted patient medical records, encrypted insurance claim information, encrypted lab results and medical imaging data, and/or the like); government records (e.g., encrypted social security numbers, encrypted tax records, encrypted records of government benefits and entitlements, and/or the like); retail and e-commerce data (e.g., encrypted customer purchase histories, encrypted loyalty program information, encrypted payment information, and/or the like); employment data (e.g., encrypted employee records, encrypted performance reviews, encrypted payroll data, and/or the like); educational records (e.g., encrypted student records, encrypted academic transcripts, encrypted financial aid and scholarship information, and/or the like); legal and compliance data (e.g., encrypted legal case files, encrypted compliance reports, encrypted contracts and agreements, and/or the like); and/or the like.

The security system 110 may encrypt the third-party data using a key management service to generate encrypted third-party data. In some implementations, the security system 110 may encrypt the third-party data in a homomorphic encryption format, a functional encryption format, and/or another secure format. The security system 110 may anonymize or tokenize sensitive fields of the third-party data before the third-party data is provided to the secure platform. The security system 110 may apply data anonymization techniques that remove or obfuscate identifiable information from the third-party data to protect third-party privacy. In some implementations, the security system 110 may encrypt the third-party data using a PKI. Additionally, or alternatively, the security system 110 may encrypt the third-party data using symmetric key cryptography. In some implementations, the security system 110 may store the encrypted third-party data in the data structure 115.

As shown in FIG. 1F, and by reference number 165, the security system 110 may determine whether the other request is valid based on one or more security policies. For example, the security system 110 may utilize the policy engine to analyze the other request for calculating analytics based on the encrypted customer data and encrypted third-party data. The policy engine may apply predefined rules and criteria to assess the validity of the other request, ensuring that the requested analytics calculation adheres to established data usage policies. The security policies may define specific conditions, such as the type of customer data fields that can be accessed, the purpose of the analytics, the time frame within which the analytics can be calculated, and/or similar criteria. In some implementations, the security system 110 may determine that the other request is invalid based on determining that the other request fails to satisfy one or more of the security policies. Alternatively, the security system 110 may determine that the other request is valid based on determining that the other request satisfies all of the security policies.

In some implementations, the security system 110 may utilize a combination of predefined rules and real-time contextual data to assess if the other request complies with established security policies. For example, the security system 110 may analyze a current network environment and user behavior to ensure that the request aligns with expected patterns before granting access. Additionally, or alternatively, the security system 110 may evaluate the other request by cross-referencing the other request with a dynamic set of security policies that take into account a current security posture and threat landscape. For example, the policy engine may adjust security criteria based on the latest threat intelligence to mitigate emerging risks. Additionally, or alternatively, the security system 110 may utilize a machine learning model to predict the validity of the other request based on historical data and predefined security criteria. This may enable the security system 110 to adapt to evolving patterns and improve accuracy over time.

The security policies may include criteria such as a geographic location of the other request, a historical behavior of a requesting entity, a sensitivity level of requested data fields, and/or the like. For example, requests originating from high-risk regions may require additional verification steps. Additionally, or alternatively, the security policies may include provisions for conditional access, where third parties can access customer data only if certain additional security measures, such as multi-factor authentication, are satisfied. Additionally, or alternatively, the security system 110 may enforce data access control by integrating biometric authentication methods to verify the identity of third parties authorized to access specific types of customer data. Biometric verification can include fingerprint scanning or facial recognition to ensure that only verified individuals can proceed with the other request. Additionally, or alternatively, the policy engine may incorporate real-time monitoring and anomaly detection to dynamically adjust the security policies based on suspicious activities detected during the request evaluation. Additionally, the security system 110 may assess the validity of the other request by using a blockchain-based ledger to verify the integrity and authenticity of the other request.

As further shown in FIG. 1F, and by reference number 170, the security system 110 may deny the other request based on determining that the other request is invalid. For example, if the policy engine of the security system 110 determines that the other request fails to meet one or more of the security policies, the security system 110 may reject the other request and prevent the analytics calculation from being executed. The security system 110 may communicate the denial of the other request to the third party via the user device 105, and may provide an explanation for the denial of the other request based on specific security policy violations. This may ensure that unauthorized or non-compliant requests are not processed, thereby maintaining the integrity and confidentiality of the customer data and the third-party data within the security system 110.

In some implementations, the security system 110 may deny the other request based on detecting discrepancies or inconsistencies in the other request metadata, such as mismatched timestamps or unauthorized network addresses. For example, if the metadata suggests that the other request was made from an unrecognized location, the security system 110 may deny the other request in order to prevent potential fraud. Additionally, or alternatively, the security system 110 may provide a graded response, where requests that partially meet security policies are subjected to additional scrutiny or require further validation from an authorized administrator. Additionally, or alternatively, the security system 110 may automatically trigger an alert and log the incident if a denied request is flagged as a potential security threat, facilitating prompt investigation and response. Additionally, or alternatively, the security system 110 may provide detailed feedback on the policy violations, including specific data fields or criteria that were non-compliant, along with recommendations for corrective actions. This feedback helps the third party understand the reasons for denial and allows the third party to rectify issues before resubmitting the request.

As shown in FIG. 1G, and by reference number 175, the security system 110 may provide the other request to the secure platform based on determining that the other request is valid, and may decrypt a portion of the encrypted customer data and a portion of the encrypted third-party data within the secure platform. For example, if the policy engine of the security system 110 determines that the other request satisfies the security policies, the security system 110 may provide the other request for analytics calculation to the secure platform of the security system 110. In some implementations, the secure platform may include a trusted execution environment that ensures the integrity and confidentiality of the customer data and the third-party data during the calculation of the analytics. In some implementations, the security system 110 may analyze the other request and may determine the portion of the encrypted customer data and the portion of the encrypted third-party data needed for calculating the analytics within the secure platform based on analyzing the other request. For example, the security system 110 may analyze the other request to understand what specific data fields or data elements are necessary for calculating the analytics. This may include examining the other request's logic, input parameters, and the type of operation it is intended to perform (e.g., fraud analytics, credit analytics, and/or the like). Based on the analysis, the security system 110 may map the required data fields from the encrypted customer data and the encrypted third-party data. The mapping may identify the portion of the customer data and the portion of the third-party data that are necessary for calculating the analytics.

In some implementations, the security system 110 may provide the other request to the secure platform and may decrypt the portions of the encrypted customer data and encrypted third-party data within the secure platform. For example, the secure platform may receive the other request from the security system 110 and, upon confirming the validity of the other request, may initiate the decryption of the portions of the encrypted customer data and third-party data required for processing. This selective decryption ensures that only the minimal necessary customer data and third-party data is exposed within the secure platform, maintaining the confidentiality and integrity of the remaining data. In some implementations, the secure platform may utilize decryption techniques such as homomorphic decryption, functional decryption, and/or other cryptographic methods to securely manage the decryption of the portion of the encrypted customer data and the portion of the encrypted third-party data. The decryption may generate a portion of the customer data and a portion of the third-party data.

As shown in FIG. 1H, and by reference number 180, the security system 110 may calculate the analytics with the portion of the customer data and the portion of the third-party data within the secure platform. For example, the secure platform of the security system 110 may receive the portion of the customer data and the portion of the third-party data, and may perform the necessary computations to calculate the analytics based on those data portions. The secure platform may ensure that the data remains secure throughout the calculation process, utilizing techniques such as homomorphic encryption or secure multi-party computation to maintain data privacy and integrity. The resulting analytics may include derived insights, aggregated metrics, risk scores, fraud detection results, or other analytical outputs relevant to the other request. The secure platform may provide an isolated environment that ensures that the portions of the customer data and the third-party data are protected from unauthorized access or tampering during computation. Additionally, or alternatively, the security system 110 may implement additional security protocols, such as ensuring data anonymity or tokenization, before calculating the analytics to further enhance data privacy. This may involve replacing sensitive data with anonymized tokens that can be mapped back to the original data only by authorized entities.

As further shown in FIG. 1H, and by reference number 185, the security system 110 may encrypt the analytics and may provide the encrypted analytics to the third party. For example, after calculating the analytics, the security system 110 may encrypt the analytics using a secure encryption format (e.g., a homomorphic encryption format, a functional encryption format, a public key infrastructure format, or a symmetric key cryptography format) to ensure the confidentiality of the analytics. The security system 110 may provide the encrypted analytics to the third party via the user device 105, ensuring that only authorized entities can decrypt and access the analytics. Additionally, or alternatively, the security system 110 may support various encryption schemes and protocols to accommodate different security requirements and regulatory standards. This flexibility allows the security system 110 to adapt to specific security needs of different industries or legal frameworks. Additionally, or alternatively, the security system 110 may also provide the third party with a detailed report of the analytics, including visualizations and summaries of key findings. Such reports can offer actionable insights and help third parties make informed decisions based on the analytics.

Additionally, or alternatively, the analytics calculation process may include validation steps to ensure the accuracy and reliability of the analytics before the analytics are encrypted and transmitted. Validation steps may include cross-checking the analytics with expected outcomes or using redundant calculations to verify accuracy. Additionally, or alternatively, the security system 110 may utilize differential privacy techniques to ensure that individual data points are not identifiable in the aggregated analytics. Differential privacy can provide strong guarantees that the inclusion or exclusion of a single data point does not significantly affect the overall analytics, thereby protecting individual privacy.

As further shown in FIG. 1H, and by reference number 190, the security system 110 may log details associated with calculation of the analytics. For example, the security system 110 may provide, to the audit log, key information related to the analytics calculation, including an identity of the requester (e.g., the third party), timestamps of the request and calculation, input parameters used, analytics identifiers, references to applicable security policies, and a type of analytics result produced. The audit log may be stored in a secure audit system to ensure its integrity and accessibility for compliance and accountability purposes. The audit log may help in tracking and monitoring the analytics calculation process and provide a reliable record for future audits and investigations.

In this way, the security system 110 provides secure third-party function execution and secure multi-party analytics calculation. For example, the security system 110 may enable secure execution of third-party functions while maintaining the confidentiality of sensitive customer data. The security system 110 may utilize a secure platform that ensures that sensitive information is processed in a protected environment that is inaccessible to unauthorized parties. The security system 110 also includes policy enforcement mechanisms that provide granular control over data access. The security system 110 may provide auditable logs that efficiently track and record only essential information related to data access and function execution. By providing robust security measures, the security system 110 adheres to stringent data protection regulations and minimizes the risk of unauthorized data access or breaches. Thus, the security system 110 may conserve computing resources, networking resources, and/or other resources that would have otherwise been consumed by handling privacy breaches of sensitive customer data, handling misuse of sensitive customer data, failing to establish a secure computation environment where third-party logic may be executed without exposing raw customer data, failing to control and limit access to customer data according to predefined rules, failing to provide an auditable system that can log every action taken on the customer data, while preserving the privacy and confidentiality requirements of customer data, and/or the like.

As indicated above, FIGS. 1A-1H are provided as an example. Other examples may differ from what is described with regard to FIGS. 1A-1H. The number and arrangement of devices shown in FIGS. 1A-1H are provided as an example. In practice, there may be additional devices, fewer devices, different devices, or differently arranged devices than those shown in FIGS. 1A-1H. Furthermore, two or more devices shown in FIGS. 1A-1H may be implemented within a single device, or a single device shown in FIGS. 1A-1H may be implemented as multiple, distributed devices. Additionally, or alternatively, a set of devices (e.g., one or more devices) shown in FIGS. 1A-1H may perform one or more functions described as being performed by another set of devices shown in FIGS. 1A-1H.

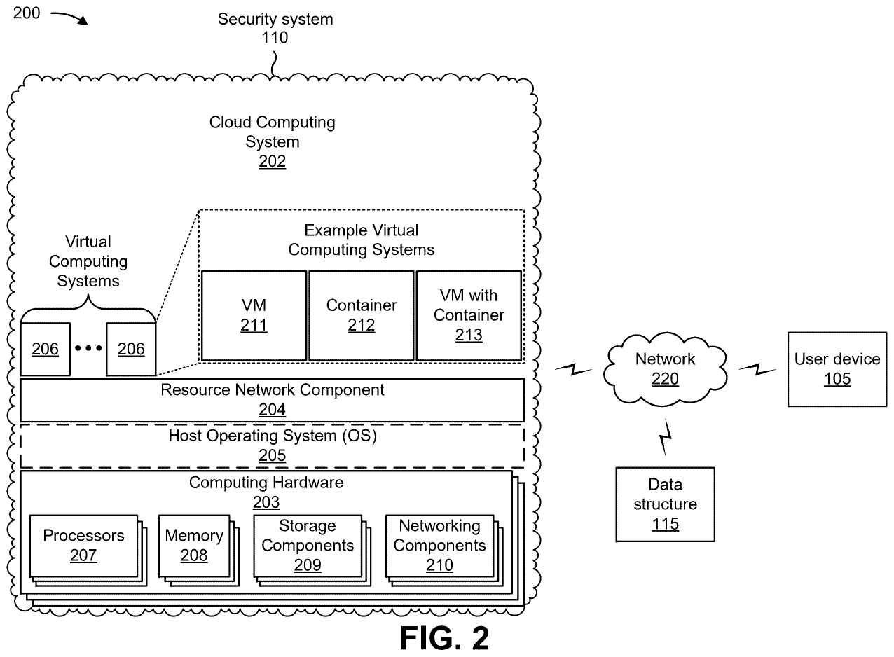

FIG. 2 is a diagram of an example environment 200 in which systems and/or methods described herein may be implemented. As shown in FIG. 2, the environment 200 may include the security system 110, which may include one or more elements of and/or may execute within a cloud computing system 202. The cloud computing system 202 may include one or more elements 203-213, as described in more detail below. As further shown in FIG. 2, the environment 200 may include the user device 105, the data structure 115, and/or a network 220. Devices and/or elements of the environment 200 may interconnect via wired connections and/or wireless connections.

The user device 105 may include one or more devices capable of receiving, generating, storing, processing, and/or providing information, as described elsewhere herein. The user device 105 may include a communication device and/or a computing device. For example, the user device 105 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The data structure 115 may include one or more devices capable of receiving, generating, storing, processing, and/or providing information, as described elsewhere herein. The data structure 115 may include a communication device and/or a computing device. For example, the data structure 115 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data structure 115 may communicate with one or more other devices of the environment 200, as described elsewhere herein.

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 includes hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as the computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 211. Additionally, or alternatively, the resource management component 204 may include a container manager, such as when the virtual computing systems 206 are containers 212. In some implementations, the resource management component 204 executes within and/or in coordination with a host operating system 205.

A virtual computing system 206 includes a virtual environment that enables cloud-based execution of operations and/or processes described herein using the computing hardware 203. As shown, the virtual computing system 206 may include a virtual machine 211, a container 212, or a hybrid environment 213 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

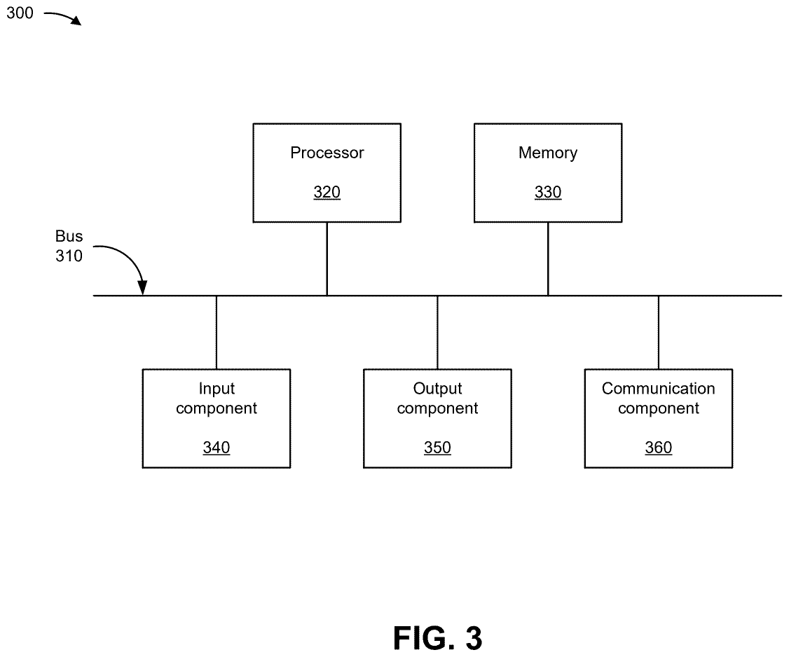

Although the security system 110 may include one or more elements 203-213 of the cloud computing system 202, may execute within the cloud computing system 202, and/or may be hosted within the cloud computing system 202, in some implementations, the security system 110 may not be cloud-based (e.g., may be implemented outside of a cloud computing system) or may be partially cloud-based. For example, the security system 110 may include one or more devices that are not part of the cloud computing system 202, such as a device 300 of FIG. 3, which may include a standalone server or another type of computing device. The security system 110 may perform one or more operations and/or processes described in more detail elsewhere herein.

The network 220 includes one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200. In some implementations, the network 220 includes a network capable of providing network slices, such as a 5G core network.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300, which may correspond to the user device 105, the security system 110, and/or the data structure 115. In some implementations, the user device 105, the security system 110, and/or the data structure 115 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

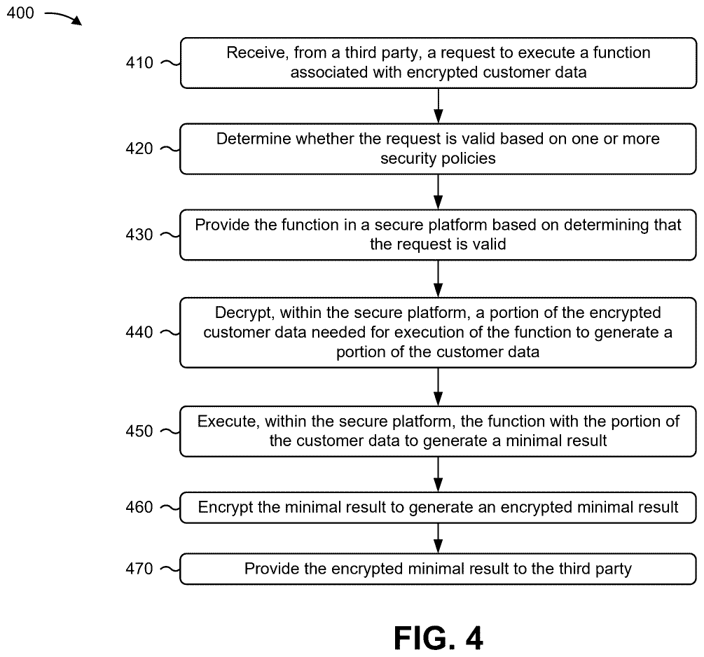

FIG. 4 depicts a flowchart of an example process 400 for providing secure third-party function execution and secure multi-party analytics calculation. In some implementations, one or more process blocks of FIG. 4 may be performed by a device (e.g., the security system 110). In some implementations, one or more process blocks of FIG. 4 may be performed by another device or a group of devices separate from or including the device, such as a user device (e.g., the user device 105). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving, from a third party, a request to execute a function associated with encrypted customer data (block 410). For example, the device may receive, from a third party, a request to execute a function associated with encrypted customer data, as described above. In some implementations, the encrypted customer data is encrypted in one of a homomorphic encryption format, a functional encryption format, a public key infrastructure format, or a symmetric key cryptography format.

As further shown in FIG. 4, process 400 may include determining whether the request is valid based on one or more security policies (block 420). For example, the device may determine whether the request is valid based on one or more security policies, as described above. In some implementations, determining whether the request is valid based on the one or more security policies includes determining whether data fields and usage context of the request are valid based on digitally signed metadata and credentials of the third party.

As further shown in FIG. 4, process 400 may include providing the function in a secure platform based on determining that the request is valid (block 430). For example, the device may provide the function in a secure platform based on determining that the request is valid, as described above. In some implementations, the secure platform includes a trusted execution environment that ensures integrity and confidentiality of the encrypted customer data during execution of the function.

As further shown in FIG. 4, process 400 may include decrypting, within the secure platform, a portion of the encrypted customer data needed for execution of the function to generate a portion of the customer data (block 440). For example, the device may decrypt, within the secure platform, a portion of the encrypted customer data needed for execution of the function to generate a portion of the customer data, as described above.

As further shown in FIG. 4, process 400 may include executing, within the secure platform, the function with the portion of the customer data to generate a minimal result (block 450). For example, the device may execute, within the secure platform, the function with the portion of the customer data to generate a minimal result, as described above. In some implementations, the minimal result includes one or more of a risk score, a yes/no decision, or aggregated data results. In some implementations, executing the function with the portion of the customer data to generate the minimal result includes utilizing homomorphic encryption to execute the function with the portion of the customer data to generate the minimal result and preserve data privacy.

As further shown in FIG. 4, process 400 may include encrypting the minimal result to generate an encrypted minimal result (block 460). For example, the device may encrypt the minimal result to generate an encrypted minimal result, as described above.

As further shown in FIG. 4, process 400 may include providing the encrypted minimal result to the third party (block 470). For example, the device may provide the encrypted minimal result to the third party, as described above.

In some implementations, process 400 includes logging details associated with execution of the function, wherein the details associated with execution of the function include one or more timestamps, one or more input parameters, an identifier of the function, the one or more security policies, and a type associated with the minimal result. In some implementations, process 400 includes receiving customer data, encrypting the customer data to generate the encrypted customer data, and storing the encrypted customer data in a data structure associated with the device. In some implementations, process 400 includes receiving the encrypted customer data from a data structure associated with the device.

In some implementations, process 400 includes receiving, from the third party, another request to calculate analytics based on the encrypted customer data and encrypted third-party data; determining whether the other request is valid based on the one or more security policies; providing the other request to the secure platform based on determining that the other request is valid; decrypting, within the secure platform, another portion of the encrypted customer data and a portion of the encrypted third-party data; calculating, within the secure platform, the analytics with the other portion of the customer data and the portion of the third-party data; encrypting the analytics to generate encrypted analytics; and providing the encrypted analytics to the third party. In some implementations, process 400 includes logging details associated with calculation of the analytics. In some implementations, logging details associated with calculation of the analytics includes storing the details associated with calculation of the analytics in a secure audit system.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

As used herein, “selectively” performing an operation means to either perform the operation or refrain from performing the operation. For example, selectively performing an operation based on whether a condition is satisfied means that the operation is performed if the condition is satisfied and that the operation is not performed if the condition is not satisfied (or vice versa). Thus, selectively performing an operation may include determining whether to perform the operation and then either performing the operation or refraining from performing the operation based on that determination.

As used herein, “selectively” performing a first operation or a second operation means to perform either the first operation or the second operation. For example, selectively performing a first operation or a second operation based on whether a condition is satisfied means that the first operation is performed if the condition is satisfied and that the second operation is performed if the condition is not satisfied (or vice versa). Thus, selectively performing a first operation or a second operation may include determining whether to perform either the first operation or the second operation and then performing either the first operation or the second operation based on that determination.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device and from a third party, a request to execute a function associated with encrypted customer data;
determining, by the device, whether the request is valid based on one or more security policies;
providing, by the device, the function in a secure platform based on determining that the request is valid;
decrypting, by the device and within the secure platform, a portion of the encrypted customer data needed for execution of the function to generate a portion of the customer data; and
executing, by the device and within the secure platform, the function with the portion of the customer data to generate a minimal result.

2. The method of claim 1, further comprising:
encrypting the minimal result to generate an encrypted minimal result; and
providing the encrypted minimal result to the third party.

3. The method of claim 1, further comprising:
logging details associated with the execution of the function,
wherein the details associated with execution of the function include one or more timestamps, one or more input parameters, an identifier of the function, the one or more security policies, and a type associated with the minimal result.

4. The method of claim 1, further comprising:
receiving customer data;
encrypting the customer data to generate the encrypted customer data; and
storing the encrypted customer data in a data structure associated with the device.

5. The method of claim 1, wherein the encrypted customer data is encrypted in one of a homomorphic encryption format, a functional encryption format, a public key infrastructure format, or a symmetric key cryptography format.

6. The method of claim 1, wherein determining whether the request is valid based on the one or more security policies comprises:
determining whether data fields and usage context of the request are valid based on digitally signed metadata and credentials of the third party.

7. The method of claim 1, wherein the secure platform includes a trusted execution environment that ensures integrity and confidentiality of the encrypted customer data during execution of the function.

8. A device, comprising:
one or more processors configured to:
receive, from a third party, a request to execute a function associated with encrypted customer data;
determine whether the request is valid based on one or more security policies;
provide the function in a secure platform based on determining that the request is valid;
decrypt, within the secure platform, a portion of the encrypted customer data needed for execution of the function to generate a portion of the customer data; and
execute, within the secure platform, the function with the portion of the customer data to generate a minimal result.

9. The device of claim 8, wherein the one or more processors are further configured to:
encrypt the minimal result to generate an encrypted minimal result;
provide the encrypted minimal result to the third party; and
log details associated with execution of the function.

10. The device of claim 8, wherein the one or more processors are further configured to:
receive, from the third party, another request to calculate analytics based on the encrypted customer data and encrypted third-party data;
determine whether the other request is valid based on the one or more security policies;
provide the other request to the secure platform based on determining that the other request is valid;
decrypt, within the secure platform, another portion of the encrypted customer data and a portion of the encrypted third-party data;
calculate, within the secure platform, the analytics with the other portion of the customer data and the portion of the third-party data;
encrypt the analytics to generate encrypted analytics.

11. The device of claim 10, wherein the one or more processors are further configured to:
log details associated with calculation of the analytics.

12. The device of claim 11, wherein the one or more processors, to log details associated with calculation of the analytics, are configured to:
store the details associated with calculation of the analytics in a secure audit system.

13. The device of claim 10, wherein the encrypted customer data is encrypted in one of a homomorphic encryption format, a functional encryption format, a public key infrastructure format, or a symmetric key cryptography format.

14. The device of claim 8, wherein the one or more processors, to execute the function with the portion of the customer data to generate the minimal result, are configured to:
utilize homomorphic encryption to execute the function with the portion of the customer data to generate the minimal result and preserve data privacy.

15. A non-transitory computer-readable medium storing a set of instructions, the set of instructions comprising:
one or more instructions that, when executed by one or more processors of a device, cause the device to:
receive, from a third party, a request to execute a function associated with encrypted customer data;
determine whether the request is valid based on one or more security policies;
provide the function in a secure platform based on determining that the request is valid;
decrypt, within the secure platform, a portion of the encrypted customer data needed for execution of the function to generate a portion of the customer data;
execute, within the secure platform, the function with the portion of the customer data to generate a minimal result;
encrypt the minimal result to generate an encrypted minimal result; and
provide the encrypted minimal result to the third party.

16. The non-transitory computer-readable medium of claim 15, wherein the one or more instructions further cause the device to:
receive customer data;
encrypt the customer data to generate the encrypted customer data; and
store the encrypted customer data in a data structure associated with the device.

17. The non-transitory computer-readable medium of claim 15, wherein the one or
more instructions further cause the device to:
receive the encrypted customer data from a data structure associated with the device.

18. The non-transitory computer-readable medium of claim 15, wherein the one or more instructions further cause the device to:
receive, from the third party, another request to calculate analytics based on the encrypted customer data and encrypted third-party data;
determine whether the other request is valid based on the one or more security policies;
provide the other request to the secure platform based on determining that the other request is valid;
decrypt, within the secure platform, another portion of the encrypted customer data and a portion of the encrypted third-party data;
calculate, within the secure platform, the analytics with the other portion of the customer data and the portion of the third-party data;
encrypt the analytics to generate encrypted analytics;
provide the encrypted analytics to the third party; and
log details associated with calculation of the analytics.

19. The non-transitory computer-readable medium of claim 18, wherein the encrypted customer data is encrypted in one of a homomorphic encryption format, a functional encryption format, a public key infrastructure format, or a symmetric key cryptography format.

20. The non-transitory computer-readable medium of claim 15, wherein the one or more instructions, that cause the device to execute the function with the portion of the customer data to generate the minimal result, cause the device to:
utilize homomorphic encryption to execute the function with the portion of the customer data to generate the minimal result and preserve data privacy.
